(19) United States
(12) Patent Application Publication
(10) Pub. No.: US 2026/0064487 A1
(43) Pub. Date: Mar. 5, 2026

(54) METHODS, SYSTEMS, AND COMPUTER READABLE MEDIA FOR EMULATING A WORKLOAD PROCESSOR USING CHECKPOINT DATA

(71) Applicant: Keysight Technologies, Inc., Santa Rosa, CA (US)

(72) Inventors: Venkateshwar Rao Pullela, San Jose, CA (US); Winston Wencheng Liu, Woodland Hills, CA (US); Dan Mihailescu, Mogosoaia (RO); Christian Paul Sommers, Bangor, CA (US)

(21) Appl. No.: 18/820,242

(22) Filed: Aug. 29, 2024

(30) Foreign Application Priority Data
Aug. 28, 2024 (RO) A 2024 00497

(51) Int. Cl. G06F 9/50

(52) U.S. Cl. CPC G06F 9/5055; G06F 9/5038

(57) ABSTRACT

A method for emulating a workload processor using checkpoint data is disclosed. Checkpoint data including outputs of an processor at predetermined checkpoints in performing a first task is stored in a checkpoint database. An emulated first workload processor receives input data relating to the first task and accesses the checkpoint database using the input data. The emulated first workload processor extracts checkpoint data corresponding to the input data from the checkpoint database. The extracted checkpoint data or data derived from the checkpoint data is output to at least one real or emulated second workload processor that is performing a second task.

### PRIORITY CLAIM

This application claims the priority benefit of Romanian Patent Application No. (Serial No. not yet assigned), filed Aug. 28, 2024, and entitled, “METHODS, SYSTEMS, AND COMPUTER READABLE MEDIA FOR EMULATING A WORKLOAD PROCESSOR USING CHECKPOINT DATA”, the disclosure of which is incorporated herein by reference in its entirety.

### TECHNICAL FIELD

The subject matter described herein relates to emulating workload processors. More specifically, the subject matter relates to methods, systems, and computer readable media for emulating a workload processor using checkpoint data.

### BACKGROUND

Thoroughly testing a workload processor, such as a graphics processing unit (GPU), requires real input data, which in turn requires another workload processor to generate the real input data for the workload processor being tested. However, workload processors are costly and procuring a second workload processor to test a workload processor is often impractical. Similarly, there is a need to further build out fabrics with numerous GPUs and GPU clusters, but such a network can be cost prohibitive.

There is a need for emulated workload processors that can substitute real workload processors for testing real workload processors or for implementation in an network.

### SUMMARY

The subject matter relates to methods, systems, and computer readable media for emulating a workload processor using checkpoint data. An example method for emulating a workload processor using checkpoint data includes storing, in a checkpoint database, checkpoint data including outputs of an processor at predetermined checkpoints in performing a first task. The method further includes receiving, at an emulated first workload processor, input data relating to the first task. The method further includes accessing, by the emulated first workload processor and using the input data, the checkpoint database. The method further includes extracting, by the emulated first workload processor and from the checkpoint database, checkpoint data corresponding to the input data. The method further includes outputting, by the emulated first workload processor, the extracted checkpoint data or data derived from the checkpoint data to at least one real or emulated second workload processor that is performing a second task.

According to another aspect of the subject matter described herein, receiving the input data includes receiving input data from a non-emulated workload processor performing the first task, input data from another emulated workload processor, or synthetic data for which the emulated first workload processor should produce a known output.

According to another aspect of the method described herein, the checkpoint data includes input data received from the processor corresponding to the outputs.

According to another aspect of the method described herein, the checkpoint data includes rank and/or process identifier information of the processor.

According to another aspect of the method described herein, the process identifier information includes weights and/or operations performed by the processor.

According to another aspect of the subject matter described herein, the method further includes generating an index using the input data to search for the checkpoint data corresponding to the input data.

According to another aspect of the method described herein, the index is generated using at least one weight or operation that the emulated first workload processor is configured to emulate.

According to another aspect of the method described herein, the emulated first workload processor is configured to emulate a graphics processing unit (GPU).

According to another aspect of the method described herein, the at least one real or emulated second workload processor includes a real GPU.

An example system for emulating an workload processor using checkpoint data includes a checkpoint database configured for storing checkpoint data including outputs of an processor at predetermined checkpoints in performing a first task. The system further includes an emulated first workload processor configured for receiving input data relating to the first task and accessing the checkpoint database using the input data. The emulated first workload processor is further configured for extracting, from the checkpoint database, checkpoint data corresponding to the input data and outputting the extracted checkpoint data or data derived from the checkpoint data to at least one real or emulated second workload processor that is performing a second task.

According to another aspect of the system described herein, the checkpoint data includes input data received from the processor corresponding to the outputs.

According to another aspect of the system described herein, the checkpoint data includes rank and/or process identifier information of the processor.

According to another aspect of the system described herein, the process identifier information includes weights and/or operations performed by the processor.

According to another aspect of the system described herein, the emulated first workload processor is configured for generating an index using the input data to search for the checkpoint data corresponding to the input data.

According to another aspect of the system described herein, the index is generated using at least one weight or operation that the emulated first workload processor is configured to emulate.

According to another aspect of the system described herein, the emulated first workload processor is configured to emulate a graphics processing unit (GPU).

According to another aspect of the system described herein, the at least one real or emulated second workload processor includes a real GPU.

An example non-transitory computer readable medium has stored thereon executable instructions that when executed by at least one processor of at least one computer cause the at least one computer to perform steps including storing, in a checkpoint database, checkpoint data including outputs of an processor at predetermined checkpoints in performing a first task. The steps further include receiving, at an emulated first workload processor, input data relating to the first task. The steps further include accessing, by the emulated first workload processor and using the input data, the checkpoint database. The steps further include extracting, by the emulated first workload processor and from the checkpoint database, checkpoint data corresponding to the input data. The steps further include outputting, by the emulated first workload processor, the extracted checkpoint data or data derived from the checkpoint data to at least one real or emulated second workload processor that is performing a second task.

According to another aspect of the non-transitory computer readable medium described herein, the checkpoint data includes input data received from the processor corresponding to the outputs.

According to another aspect of the non-transitory computer readable medium described herein, the checkpoint data includes rank and/or process identifier information of the processor.

According to another aspect of the non-transitory computer readable medium described herein, the steps include generating, by the emulated first workload processor, an index using the input data to search for the checkpoint data corresponding to the input data.

The subject matter described herein may be implemented in software in combination with hardware and/or firmware. For example, the subject matter described herein may be implemented in software executed by a processor. In one example implementation, the subject matter described herein may be implemented using a non-transitory computer readable medium having stored therein computer executable instructions that when executed by the processor of a computer control the computer to perform steps. Example computer readable media suitable for implementing the subject matter described herein include non-transitory devices, such as disk memory devices, chip memory devices, programmable logic devices, field-programmable gate arrays, and application specific integrated circuits. In addition, a computer readable medium that implements the subject matter described herein may be located on a single device or computer platform or may be distributed across multiple devices or computer platforms.

### BRIEF DESCRIPTION OF THE DRAWINGS

The subject matter described herein will now be explained with reference to the accompanying drawings of which:

FIG. 1 is a block diagram illustrating an example collective communication of workload processors in a fabric;

FIG. 2 is an example flow diagram illustrating checkpoint data capture;

FIG. 3 is a block diagram illustrating a system for emulating a workload processor using checkpoint data;

FIG. 4 shows a block diagram illustrating an example collective communication architecture including an emulated workload processor; and

FIG. 5 is a flow diagram illustrating an example method for emulating a workload processor using checkpoint data.

### DETAILED DESCRIPTION

The subject matter described herein includes methods, systems, and computer readable media for emulating an workload processor using checkpoint data. The emulated workload processor can provide output data based on input data in which the output data is the same as the output data that a real workload processor, such as a real GPU, would compute. A checkpoint database has stored checkpoint data collected from real workload processors and includes the input data the workload processors received and the corresponding output data computed. The checkpoint data can include additional parameters for each input/output entry, such as identification and rank of the workload processor and at least one weight and/or operation performed by the workload processor. The emulated workload processor receives input data and uses the received input data to extract from the checkpoint database corresponding output data that was computed by a real workload processor. The emulated workload processor sends the retrieved output data as if it were computed. The emulated workload processor can use one or more additional parameters to extract corresponding output data such as identification and rank of the workload processor being emulated and the weight and operation performed by the workload processor being emulated. The emulated workload processor can implement an indexing function (e.g. hash) to generate a lookup based on the parameters for extracting the corresponding output data from the checkpoint database.

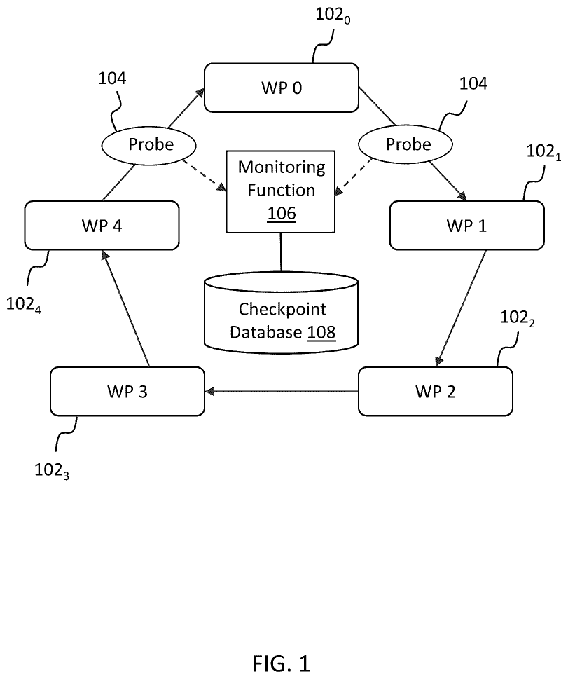

FIG. 1 is a block diagram illustrating an example collective communication of workload processors (WPs). The workload processors can be Artificial Intelligence/Machine Learning (AI/ML) WPs implemented as part of an AI/ML fabric or WPs for implementing any other process performed over a distributed network, for example cryptocurrency management such as cryptocurrency transaction verification and coin generation. Workload processors can include without limitation accelerators, for example GPUs, Field-Programmable Gate Arrays (FPGAs), Tensor Processing Units (TPUs), and Application-Specific Integrated Circuits (ASICs). WP 0 102₀, WP 1 102₁, WP 2 102₂, WP 3 102₃, and WP 4 102₄ communicate in an example ring topology. WP 0 102₀ receives input data from WP 4 102₄ and computes output data based on the input data received and sends the computed output data to WP 1 102₁. The output data from WP 0 102₀ is received as input data at WP 1 102₁ and WP 1 102₁ computes output data based on the received input data, sending the output data to WP 2 102₂. Similarly, WP 2 102₂ computes output data based on the received input data from WP 1 102₁ and, sends the output data to WP 3 102₃. WP 3 102₃ receives as input data the output data generated by WP 2 102₂, generates output data based on the input data, and sends the output data to WP 4 102₄. WP 4 102₄ in turn generates output data based on the received data from WP 3 102₃ and sends the generated output data to WP 0 102₀, which is input data for WP 0 102₀. The WPs can generate the output data using one or more activation functions including at least one weight and/or bias.

Intermediate states and results of an implemented fabric are saved at checkpoints to provide a backup for a warm start in case of an error during execution or to allow a user to backtrack iterations or steps to a previous iteration or step if the model diverges from accurate outputs. A distributed network can save related information to this end at predetermined checkpoints. For example, PyTorch saves model architecture at designated checkpoints, such as layer type, activation type, and connections. PyTorch also saves model weights and bias, optimizer states, and user-defined variables, such as epoch, loss, and activations.

Probes 104 are positioned at checkpoint locations, which in FIG. 1 is at the input and output of WP 0 102₀. Probes 104 capture data being transmitted between WPs, such as data from WP 4 102₄ to WP 0 102₀ that is input data for WP 0 102₀ and data from WP 0 102₀ to WP 1 102₁ that is output data from WP 0 102₀. Probes 104 can forward the captured data to a monitoring function 106 configured to monitor when a state of a sending WP has changed and/or when the sending WP has computed results, i.e., when there is a computation, which can then forward the data to a checkpoint database 108. Checkpoint database 108 can store the described data collected at the checkpoints.

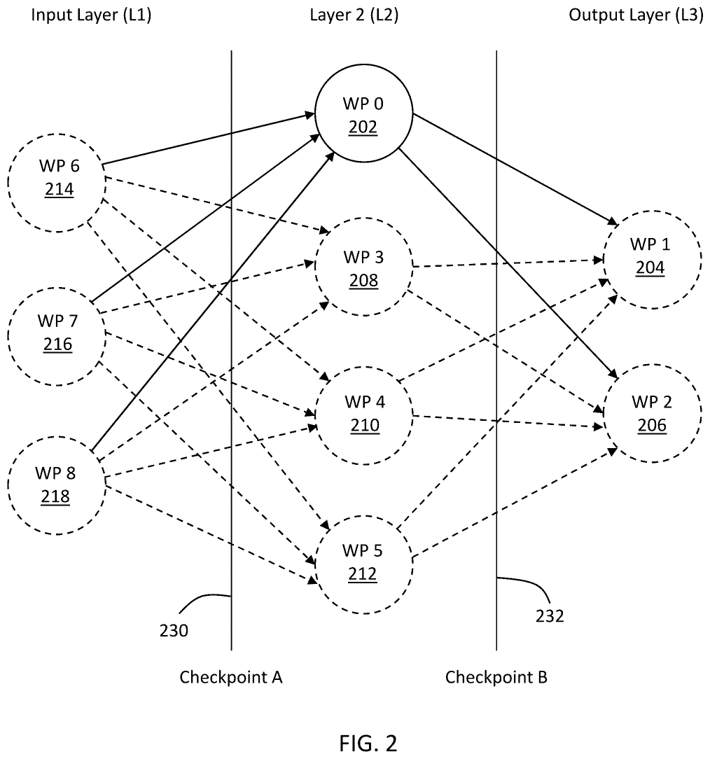

FIG. 2 is an example flow diagram illustrating checkpoint data capture. Workload processors in Layer 1 (L1), which is the input layer in this example, each performs an task, such as an AI/ML or cryptocurrency task, and computes output data that is sent to each workload processor in Layer 2 (L2) that each uses the received information to perform another task and computes an output that is then sent to each workload processor in Layer 3 (L3) to perform tasks. In the example shown in FIG. 2, L1 and L3 are the input layer and output layer, respectively. It is understood that L1 and/or L3 can be inner layers similar to L2 within a fabric.

In FIG. 2, all the workload processors in a layer send their output to each workload processor in the next layer. Checkpoints are also positioned between the layers to collect data transmitted between the layers. WP 6 214, WP 7 216, and WP 8 218 in L1 all send their output to each of WP 0 202, WP 3 208, WP 4 210, and WP 5 212 in L2. Checkpoint A 230 is located between the workload processors in L1 and the workload processors in L2 wherein at least one probe collects checkpoint data. WP 0 202, WP 3 208, WP 4 210, and WP 5 212 in L2 each perform a task using the received information and send an output to each of WP 1 204 and WP 2 206 in L3. Checkpoint B 232 is located between the workload processors in L2 and the workload processors in L3 wherein at least one probe collects checkpoint data. In other aspects of the described subject matter, workload processors can receive inputs from less than all the workload processors in the previous layer and/or send outputs to less than all the processors in the next layer. For example, WP 0 202 can receive information as input from only WP 6 214 and send the computed output to only WP 1 204.

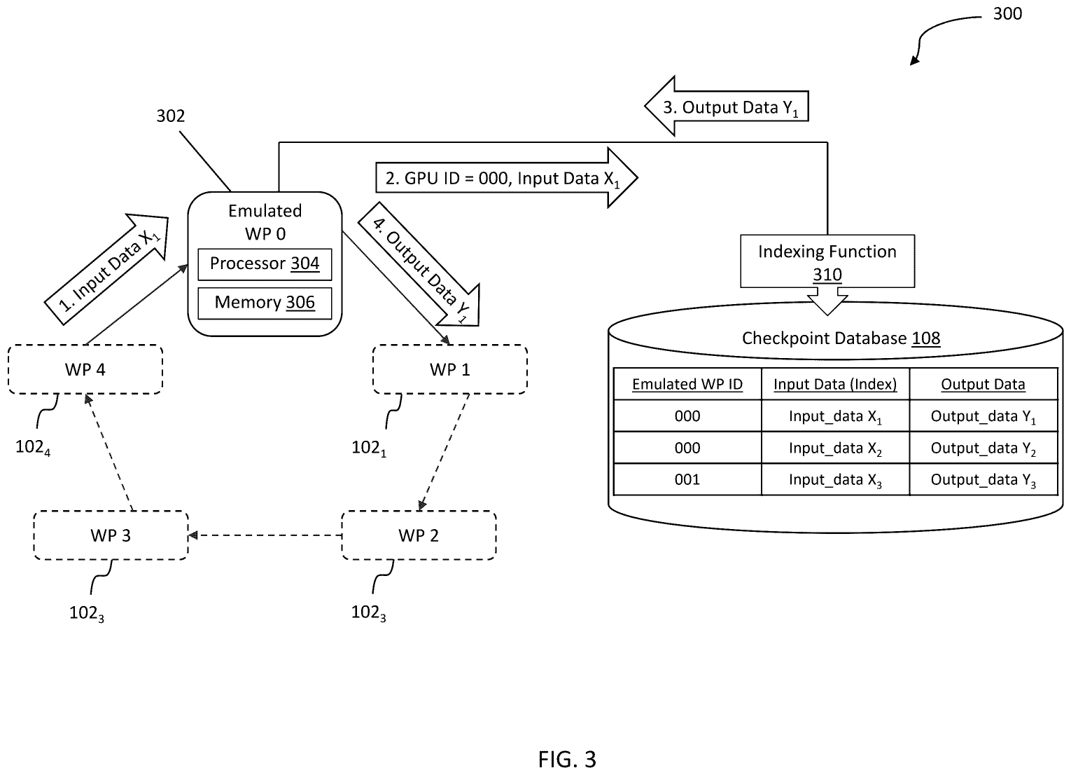

FIG. 3 is a block diagram illustrating an example 300 method for emulating a workload processor using checkpoint data. System 300 includes an emulated workload processor 302 with at least one processor 304 and memory 306. As shown in FIG. 3, emulated workload processor 302 may include, without limitation, a microcontroller, microprocessor, digital signal processor (DSP) and/or system on a chip (SoC) as described herein. Emulated workload processor 302 may include a single computing device operating independently, or may include two or more computing devices operating in concert, in parallel, sequentially or the like; two or more computing devices may be included together in a single computing device or in two or more computing devices. Emulated workload processor 302, using processor 304 and memory 306, may be configured to perform any of the steps described herein. Emulated workload processor 302 is communicatively connected to at least one checkpoint database 108. Checkpoint database 108 can include a cloud drive. In an aspect of the described subject matter, emulated workload processor 302 can store at least a portion of the contents of checkpoint database 108 locally in memory 306 or a local database. Checkpoint database 108 can include checkpoint data collected from probes 104 as shown in FIG. 1.

Checkpoint database 108 stores checkpoint data including outputs of an processor at predetermined checkpoints in performing a first task. The checkpoint data can include input data received from processors and the corresponding output data generated by the processors, such as the checkpoint data collected by probes 104 at checkpoints in FIG. 1. The checkpoint data can include real input data (generated by a real workload processor) that was used by another real workload processor to compute real output data. The checkpoint data can also include output data computed by a real workload processor, but the input data was synthetic or not generated by another real workload processor. For example, input data for a real workload processor can be manually inputted or preselected rather than output data generated from another workload processor. In this manner, inputs can be selected to determine output patterns computed by a real workload processor so inputs/outputs not tested and saved as checkpoint data can be accurately extrapolated. The synthetic data itself can be patterned. For example, a synthetic input can be selected that represents a group of possible inputs, whereas outputs generated from inputs in the group are either equivalent to the output generated from the selected synthetic input or can accurately be extrapolated from the synthetic input and its corresponding output. This provides for adequate checkpoint data without needing to save every possible input and corresponding output. Checkpoint data in checkpoint database 108 can also include the ranks and/or process identifier information of the processors that computed the saved output data. Examples of process identifier information can include weights, biases, and/or operations performed by the processors. As shown in FIG. 3, checkpoint database 108 includes checkpoint data of emulated WP ID, which can identify characteristics of or an exact workload processor being emulated, input data that was provided to the identified workload processor, and the corresponding output data computed by the identified workload processor.

In the example shown in FIG. 3, emulated AI/ML workload processor 302 is configured for emulating WP 0 102₀ shown in FIG. 1. It is understood that emulated workload processor 302 can be configured for emulating any workload processor described herein. Unlike WP 0 102₀, which computes output data using the input data received from PGU 4 102₄, emulated workload processor 302 does not compute the output data. Instead, emulated workload processor 302 extracts saved output data corresponding to the input data. As shown in FIG. 3 at step 1, emulated workload processor 302 receives input data X₁. Input data X₁ can be computed by another workload processor, such as WP 4 102₄, or input data X₁ can be provided to emulated workload processor 302 from a database of stored examples of inputs.

At step 2, emulated workload processor 302 uses at least one parameter, such as input data X_{1,} to access checkpoint database 108. Emulated workload processor 302 can use additional parameters to access checkpoint database 108, such as identification of the workload processor that emulated workload processor 302 is emulating. In the example shown in FIG. 3, emulated workload processor 302 is emulating WP ID=000 and this information is used with input data X₁ to access checkpoint database 108. Emulated workload processor 302 can also use at least one weight, bias, and/or operation that emulated workload processor 302 is configured to emulate. System 300 can include an indexing function 310 (such as a hashing function) configured for generating an index using the described at least one parameter to search for checkpoint data, specifically output data, in checkpoint database 108 corresponding to input data X₁. For example, indexing function 310 uses input data X₁ and can further use identification, rank, at least one weight, bias, and/or operation that emulated workload processor 302 is configured to emulate. Indexing function 310 can be included in emulated workload processor 302 or communicatively connected to emulated workload processor 302 and checkpoint database 108.

At step 3, emulated workload processor 302 extracts from checkpoint database 108 checkpoint data corresponding to the input data. In the example shown in FIG. 3, indexing function 310 generates an index, such as a hash, using WP ID=000 and input data X₁ and extracts the associated output data, specifically output data Y₁. Emulated workload processor 302 retrieves the extracted data. At step 4, emulated workload processor 302 sends output data Y₁ to the designated at least one real or emulated workload processor according to a specified topology, which in this example is WP 1 102₁, which will use output data Y₁ as input to execute a second task and compute an output. In another example, rather than outputting the checkpoint data to the designated real or emulated workload processor, the emulated workload processor may perform the compute task given the conditions specified by the checkpoint data and output data derived from the checkpoint data to the designated real or emulated workload processor.

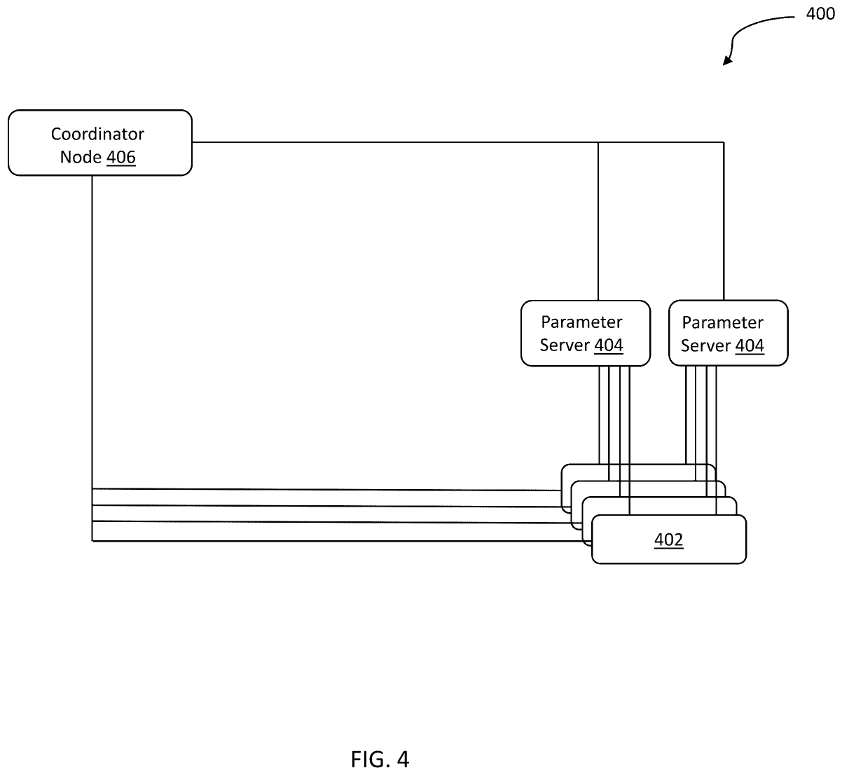

FIG. 4 shows a block diagram illustrating an example collective communication architecture 400. The input data that is used to extract checkpoint data from checkpoint database 108 can be sent from a node other than emulated workload processor 302, as shown in FIG. 3, such as a parameter server 402 or a coordinator node 404.

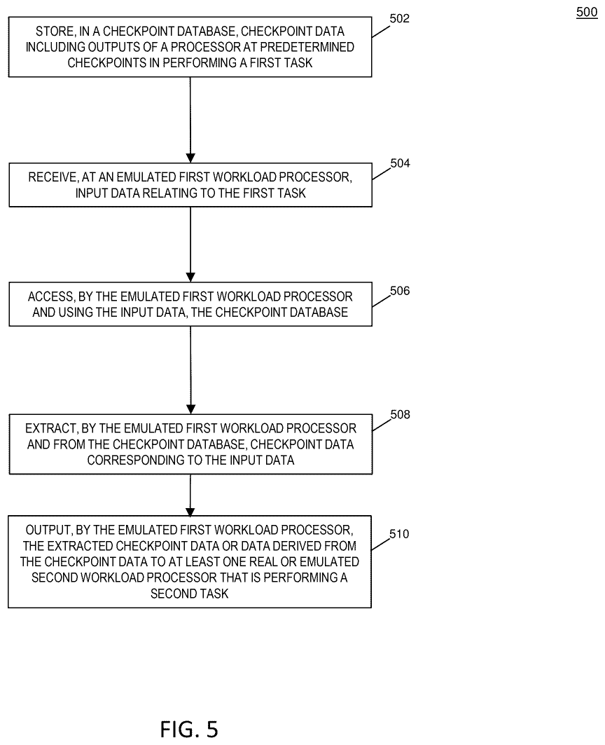

FIG. 5 is a flow diagram illustrating an example method 500 for emulating a workload processor using checkpoint data. At step 502, checkpoint data including outputs of a processor at predetermined checkpoints in performing a first task is stored in a checkpoint database. The checkpoint data can include input data received from the processor corresponding to the outputs. The checkpoint data can include rank and/or process identifier information of the processor. The process identifier information can include weights and/or operations performed by the processor.

At step 504, an emulated first workload processor receives input data relating to the first task. The emulated first workload processor can be configured to emulate a graphics processing unit (GPU). The input data may be real input data from a real (i.e., non-emulated) GPU performing a processing task, emulated input data from another emulated GPU performing a processing task, or synthetic data for which the emulated workload processor should produce a known output to verify the proper operation of the emulated workload processor.

At step 506, the emulated first workload processor accesses the checkpoint database using the input data.

At step 508, the emulated first workload processor extracts checkpoint data corresponding to the input data from the checkpoint database. The first workload processor can generate an index using the input data to search for the checkpoint data corresponding to the input data. The index can be generated using at least one weight or operation that the emulated first workload processor is configured to emulate.

At step 510, the emulated first workload processor outputs the extracted checkpoint data or data derived from the checkpoint data to at least one real or emulated second workload processor that is performing a second task. The at least one real or emulated second workload processor can include a real GPU. It will be appreciated that method 500 is for illustrative purposes and that different and/or additional actions may be used. It will also be appreciated that various actions described herein may occur in a different order or sequence. It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for emulating a workload processor using checkpoint data, the method comprising:
storing, in a checkpoint database, checkpoint data including outputs of a processor at predetermined checkpoints in performing a first task;
receiving, at an emulated first workload processor, input data relating to the first task;
accessing, by the emulated first workload processor and using the input data, the checkpoint database;
extracting, by the emulated first workload processor and from the checkpoint database, checkpoint data corresponding to the input data; and
outputting, by the emulated first workload processor, the extracted checkpoint data or data derived from the checkpoint data to at least one real or emulated second workload processor that is performing a second task.

2. The method of claim 1 wherein receiving the input data includes receiving input data from a non-emulated workload processor performing the first task, input data from another emulated workload processor, or synthetic data for which the emulated first workload processor should produce a known output.

3. The method of claim 1 wherein the checkpoint data includes input data received from the processor corresponding to the outputs.

4. The method of claim 3 wherein the checkpoint data includes rank and/or process identifier information of the processor.

5. The method of claim 4 wherein the process identifier information includes weights and/or operations performed by the processor.

6. The method of claim 1 comprising generating an index using the input data to search for the checkpoint data corresponding to the input data.

7. The method of claim 6 wherein the index is generated using at least one weight or operation that the emulated first workload processor is configured to emulate.

8. The method of claim 1 wherein the emulated first workload processor is configured to emulate a graphics processing unit (GPU).

9. The method of claim 1 wherein the at least one real or emulated second workload processor includes a real GPU.

10. A system for emulating a workload processor using checkpoint data, the method comprising:
a checkpoint database configured for storing checkpoint data including outputs of a processor at predetermined checkpoints in performing a first task;
an emulated first workload processor configured for:
receiving input data relating to the first task;
accessing the checkpoint database using the input data;
extracting, from the checkpoint database, checkpoint data corresponding to the input data; and
outputting the extracted checkpoint data or data derived from the checkpoint data to at least one real or emulated second workload processor that is performing a second task.

11. The system of claim 10 wherein receiving the input data includes receiving input data from a non-emulated workload processor performing the first task, input data from another emulated workload processor, or synthetic data for which the emulated first workload processor should produce a known output.

12. The system of claim 10 wherein the checkpoint data includes input data received from the processor corresponding to the outputs.

13. The system of claim 10 wherein the checkpoint data includes rank and/or process identifier information of the processor.

14. The system of claim 13 wherein the process identifier information includes weights and/or operations performed by the processor.

15. The system of claim 10 wherein the emulated first workload processor is configured for generating an index using the input data to search for the checkpoint data corresponding to the input data.

16. The system of claim 15 wherein the index is generated using at least one weight or operation that the emulated first workload processor is configured to emulate.

17. The system of claim 10 wherein the emulated first workload processor is configured to emulate a graphics processing unit (GPU).

18. The system of claim 10 wherein the at least one real or emulated second workload processor includes a real GPU.

19. A non-transitory computer readable medium having stored thereon executable instructions that when executed by at least one processor of at least one computer cause the at least one computer to perform steps comprising:
storing, in a checkpoint database, checkpoint data including outputs of a processor at predetermined checkpoints in performing a first task;
receiving, at an emulated first workload processor, input data relating to the first task;
accessing, by the emulated first workload processor and using the input data, the checkpoint database;
extracting, by the emulated first workload processor and from the checkpoint database, checkpoint data corresponding to the input data; and
outputting, by the emulated first workload processor, the extracted checkpoint data to at least one real or emulated second workload processor that is performing a second task.

20. The non-transitory computer readable medium of claim 19 wherein the checkpoint data includes input data received from the processor corresponding to the outputs.
